(19) United States
(12) Patent Application Publication
(10) Pub. No.: US 2010/0099434 A1
(43) Pub. Date: Apr. 22, 2010

(54) SIGNAL CAPTURING APPARATUS AND SIGNAL CAPTURING METHOD

(75) Inventors: Kei Murayama, Sendai-shi (JP); Kazuhiro Nojima, Yokohama-shi (JP); Akifumi Miyano, Yokohama-shi (JP); Hirofumi Yoshida, Yokohama-shi (JP); Hiroshi Katayama, Yokohama-shi (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/593,219

(22) PCT Filed: Mar. 29, 2007
(86) PCT No.: PCT/JP2007/056946

§ 371 Date: Sep. 25, 2009

(51) Int. Cl. H04W 24/00

(52) U.S. Cl. 455/456.1

(57) ABSTRACT

A signal capturing apparatus and a signal capturing method wherein the timing at which to implement the clock frequency correction of a GPS reception part during position determination can be optimized to prevent any search omissions, while shortening the time period required for the position determination. A cellular clock precision estimating function part (120) estimates a reception quality of wireless communication. When an estimated reception quality is equal to or greater than a predetermined threshold value, a corrected timing deciding part (140) implements a GPS clock frequency correction with the cellular clock used as a reference. When the reception quality is less than the predetermined threshold value, the corrected timing deciding part (140) inhibits the GPS clock frequency correction from being implemented with the cellular clock used as a reference.

### TECHNICAL FIELD

The present invention relates to a signal capturing apparatus and signal capturing method for capturing signals of a predetermined frequency such as signals sent out from, for example, GPS (Global Positioning System) satellites. More particularly, the present invention relates to a signal capturing apparatus and signal capturing method suitable for mobile communication terminals such as mobile telephones.

### BACKGROUND ART

Recently, mobile communication terminals that enable high speed data transmission such as mobile telephones and PDA's (Personal Digital Assistants) are becoming popular. With such mobile communication terminals, adding a function of acquiring position information utilizing a satellite positioning system for improved convenience and expanded use thereof, is gaining attention.

A satellite positioning system receives information sent from a plurality of satellites going around the earth's orbit, measures the distance between the satellite positioning system and each satellite, and calculates the current location of an apparatus on the receiving side. GPS, established by the United States Department of Defense, is a typical satellite positioning system, and provides a plurality of satellites referred to as “GPS satellites.”

A GPS satellite performs spectrum spreading processing using predetermined PRN (Pseudo Random Noise) codes with respect to signals to be sent out. That is, a mobile communication terminal can acquire original signals by performing despreading processing of the signals sent out from these GPS satellites (hereinafter referred to “GPS signals”) using the matching PRN codes. Then, information about the current location of this mobile communication terminal and the current time can be acquired by carrying out processing such as message synchronization, ephemeris collection and PVT (Position, Velocity, Time) calculation.

In such mobile communication terminals mounting a positioning function, crystal oscillators are usually adopted as apparatuses that generate clock signals (hereinafter “GPS clock signals”) to use in the processing of receiving GPS signals because these oscillators are small and cheap (see, for example Patent Document 1).

However, the frequencies oscillated by a crystal oscillator fluctuates due to the temperature of the surroundings and conditions of use, and, therefore, the search frequency range needs to be set greater. As a result, there are cases where it takes time to capture satellite signals. What was conventionally proposed is to use clock signals of high frequency precision acquired when radio communication is performed between a mobile communication terminal and a radio base station on the ground and to detect how much the frequencies of GPS clock signals generated in the crystal oscillator inside the mobile communication terminal are shifted from the ideal value. Further, signal processing related to positioning is performed based on the difference between these frequencies. By this means, even if the frequencies of GPS clock signals (hereinafter “GPS clock frequencies”) generated by the crystal oscillator are different from the ideal value, it is possible to limit the frequency search range and capture signals at high speed.

Here, with PRN code used in the above spectrum spreading processing of GPS signals, the code length is 1 ms, the chip rate is 1.023 MHz and the period of one chip is about 1 μs. This spectrum spreading processing is performed in synchronization with the times of the atomic clocks that are mounted in GPS satellites. Consequently, if a mobile communication terminal cannot establish time synchronization with the times of GPS satellites on the transmitting side at precision with the margin of error equal to or less than 0.5 μs, the communication mobile terminal cannot start processing subsequent to the above message synchronization and cannot perform positioning.

In a state where a mobile communication terminal did not start receiving GPS signals, generally, this mobile communication terminal operates irrespectively of any GPS satellite. Then, prior to positioning, it is necessary to search for GPS signals first, and establish frequency synchronization or phase synchronization, or synchronization of PRN codes (hereinafter “code synchronization” collectively) with GPS signals.

FIG. 1 shows a configuration of a communication system in which a conventional signal capturing apparatus is used. In FIG. 1, communication system 1 is formed mainly with mobile telephone 10, radio base station 2 and GPS (SPS (solar power satellite)) satellite 3 (here, one GPS satellite out of one or more GPS satellites is shown) arranged in the sky above mobile telephone 10.

Mobile telephone 10 transmits and receives radio signals to and from radio base station 2 to communicate with another mobile telephone, fixed-line phone or information server (not shown). Further, positioning is performed by capturing GPS signals sent out from one or more GPS satellites 3 and extracting information from each GPS signal. Each GPS signal refers to a signal acquired by superimposing a carrier of the same frequency 1,57542 GHz with PRN code such as C/A code (Coarse/Acquisition Code) or P code (Precise Code or Protected Code) that varies between satellites.

Mobile telephone 10 is constituted by radio antenna 11, cellular radio transmitting-receiving section 12, cellular clock generating section 13, GPS antenna 14, GPS receiving section 15, GPS clock generating section 16, positioning calculation section 17, frequency comparing section 18 and search controlling function section 19.

Mobile telephone 10 refers to a mobile communication terminal that has the function of establishing connection with radio base station 2 and the positioning function using a GPS system. Mobile telephone 10 is configured by a CPU (not shown), a storing medium that stores a control program such as a ROM, a working memory such as a RAM and a communication circuit as existing hardware, and the function of each above-described section is implemented by executing the control program on the CPU.

Cellular radio transmitting-receiving section 12 transmits and receives radio signals to and from radio base station 2, and establishes frequency synchronization with the base station to communicate with, to improve precision of cellular clocks. Radio base station 2 has a clock oscillator that generates clock signals at high frequency precision. Then, radio base station 2 generates carrier frequencies from these clock signals to perform radio communication with cellular radio transmitting-receiving section 12. Cellular radio transmitting-receiving section 12 has an AFC (Automatic Frequency Control) apparatus with a PLL (Phase-Locked Loop) circuit (not shown), and establishes frequency synchronization between the carrier frequencies of radio signals sent out from radio base station 2 to make cellular clocks generated in cellular clock generating section 13 more precise.

GPS receiving section 15 searches for and captures GPS signals, and acquires information included in the GPS signals. Then, positioning calculation section 17 performs calculation based on the acquired information to perform positioning. To be more specific, GPS receiving section 15 performs a satellite search for the GPS signals from the satellites inputted from GPS antenna 14, based on the search frequency set in search controlling function section 19, and establishes code synchronization. GPS receiving section 15 has a plurality of channels that perform the same operation.

GPS clock generating section 16 supplies clock signals for operating the GPS receiving section. GPS clock generating section 16 generates GPS clock signals used as operation clocks of GPS receiving section 15 by using a temperature compensated crystal oscillator (TCXO, not shown). GPS clock generating section 16 does not establish frequency synchronization as in the AFC apparatus in cellular radio transmitting-receiving section 12 of mobile telephone 10, and is the automatic source that generates clocks. Further, although a temperature compensated type crystal oscillator is used, the oscillation frequency of the crystal oscillator fluctuates due to the influence of the temperature of the surroundings. Therefore, frequency precision of the GPS clock signal is lower than frequency precision of the reference clock signal of cellular radio transmitting-receiving section 12 that establishes frequency synchronization with radio base station 2.

Positioning calculation section 17 performs positioning calculation based on satellite capture information of a plurality of channels such as the code phases, frequencies and signal levels of the time when code synchronization is established in GPS receiving section 15, and outputs a positioning result.

Frequency comparing section 18 outputs information about the difference between the GPS clock frequency and the cellular clock frequency. Frequency comparing section 18 has the frequency correction controlling function for outputting information about the difference between the GPS clock frequency and the cellular clock frequency.

Search controlling function section 19 determines the center frequency for performing a satellite search (i.e. search reference frequency) based on information about the frequency difference from the frequency comparing section. The frequencies that are used to search for satellites are sequentially set based on the search reference frequency. The number of frequencies to be searched for is set to the number of channels which GPS receiving section 15 can search at the same time. The frequency to be searched for is changed until code synchronization in each channel is established in GPS receiving section 15.

With the above configuration, mobile telephone 10 having the signal capturing apparatus corrects frequencies according to the following method.

While the TCXO and the like used to generate GPS clocks provides low frequency precision of several ppm, precision of clocks needs to be secured in units of 0.1 ppm to perform GPS positioning in a short time. Therefore, a conventional configuration uses clocks (i.e. radio communication clocks) that are used when radio communication is performed. The frequencies of cellular clocks are synchronized with the source of the frequency used by the base station of high frequency precision, and, consequently, it is possible to secure precision of clocks in units of 0.1 ppm. With the conventional configuration, GPS clocks are corrected based on these cellular clocks, and the satellite frequency, which serves as the center frequency of a satellite search, is set, so that it is possible to perform a satellite frequency search at high frequency precision.

FIG. 2 and FIG. 3 illustrate examples of a conventional satellite search for GPS signals, and FIG. 2 shows an example where the GPS clock frequency does not fluctuate and FIG. 3 shows an example where the GPS clock frequency fluctuates linearly in the time domain. In FIG. 2 and FIG. 3, the horizontal axis represents the lapse time since the search was started, and the vertical axis represents the frequency. The mobile communication terminal (i.e. mobile telephone 10) gradually shifts search target frequency 21, which is the target frequency to be searched for, to the surrounding frequency bands, gradually, over time based on the frequency fₛ (hereinafter, “satellite search reference frequency”) which serves as the reference for a search and which is determined in advance, as the standard frequency of GPS signals. This is because, due to relative speeds between GPS satellites and a mobile communication terminal and other factors, the frequency f₀ of a satellite (here, the frequency of the GPS signal), which is the frequency of the GPS signal arriving the mobile communication terminal, fluctuates, and therefore some unidentifiable differences are produced between f₀ and fₛ, and the surrounding frequency bands of fₛ need to be searched. With this example, the GPS signal is captured at time t₁. Further, if the mobile communication terminal receives assistance information such as information about the orbits of GPS satellites through communication with a server provided in the mobile telephone network, the mobile communication terminal can estimate fluctuation in the frequency f₀ of the GPS signal due to the relative speeds between GPS satellites and the mobile communication terminal and other factors, and set fₛ more accurately (that is, reduce the difference between f₀ and fₛ). In this case, it is possible to capture the GPS signal at an earlier time.

Meanwhile, when the search range is widened, the time required for a search increases accordingly. Further, if the time required for a search is reduced by increasing the search speed, the GPS signal is more likely to be missed when the signal level is low. Therefore, the value of the frequency upper limit fₘₐₓ and the value of the frequency lower limit fₘᵢₙ are generally determined to search target frequency 21 as shown in FIG. 2. Then, by shifting search target frequency 21 to its upper limit value and lower limit value at a speed such that search target frequency 21 reaches its upper limit value and lower limit value in a predetermined time, it is possible to finish a search in a predetermined period in the set search range A, that is, in the frequency band between the value of the frequency upper limit fₘₐₓ and the value of frequency lower limit fₘᵢₙ. Here, even if the GPS signal cannot be captured after the search is finished, a series of searching processing (described below) are executed again.

FIG. 4 is a flowchart showing satellite signal searching processing by mobile telephone 10 having a signal capturing apparatus. In FIG. 4, S represents a step in the flowchart.

First, information about the difference between the GPS clock frequency and the cellular clock frequency is acquired in step S1, and the satellite search reference frequency fₛ is corrected based on information about the frequency difference acquired in step S2. Next, the search frequency is reset once in step S3, and the search frequency is searched for in step S4.

Whether or not a satellite signal is successfully captured is decided in step S5, and, if the satellite signal is successfully captured, it is decided that the satellite signal search is finished and this flow is finished. If the satellite signal is captured successfully, the search frequency is changed in step S6, and whether or not the search frequency is within the search range is decided in step S7. If the search frequency is out of the search range, the search frequency is reset in step S8, the flow proceeds to step S4 and the search frequency is searched for in step S4. Further, if the search frequency is not out of the search range, the flow proceeds to step S4 as is and the search frequency is searched for in step S4.

The above flow can be explained as the following searching method using FIG. 2 and FIG. 3.

As shown in FIG. 2, the frequency of a satellite is searched for by gradually widening the search range around the satellite search reference frequency fₛ which is corrected based on a cellular clock. The difference between the frequency f₀ of the satellite and the satellite search reference frequency fₛ is determined mainly based on frequency precision (i.e. frequency accuracy) in the radio communication section (i.e. cellular radio transmitting-receiving section 12), and therefore the essential requirement is that the search range is set such that the satellite reference frequency fₛ covers frequency precision (here, A [ppm]) in the radio communication section.

The satellite search frequency is expanded around the satellite search reference frequency fₛ as shown by the hatching portion in FIG. 2, and a search for the satellite frequency continues until the search frequency matches with the frequency fₒ of the satellite. In FIG. 2, search finish time t₁ comes when search target frequency 21 matches with the frequency f₀ of the satellite. Further, as shown by the bold solid line, there is no frequency fluctuation in the GPS oscillator, and therefore there is no fluctuation in the satellite search reference frequency fₛ, which is the center frequency for capturing satellites.

The satellite frequency is searched for by widening the search range A, and, consequently, making smaller the difference between the satellite search reference frequency fₛ and the frequency f₀ of the satellite contributes significantly to reducing the search finish time t₁.

With a conventional example, increasing precision of this satellite search frequency fₛ by correcting the frequency contributes to reducing the time required for positioning.

### Patent Document 1: Japanese Patent Application Laid-Open No. 2003-329761

### DISCLOSURE OF INVENTION

### Problems to be Solved by the Invention

However, there is the following problem in the mobile communication terminal having such a conventional signal capturing apparatus.

Although the satellite search reference frequency fₛ is corrected based on a cellular clock when search is started, the following operation is performed based on the GPS clock. Therefore, when the GPS clock frequency fluctuates, the satellite search reference frequency fₛ used for performing a satellite frequency search also fluctuates. Although the TCXO and so on is generally used to generate GPS clocks, the TCXO has a characteristic of changing its frequency depending on the temperature of the surroundings.

FIG. 3 shows an example where the GPS clock frequency fluctuates linearly in the time domain and the satellite search reference frequency fₛ (shown by the bold, solid line) changes.

As shown in FIG. 3, if the GPS clock frequency fluctuates, the satellite search reference frequency fₛ, which is the center frequency for capturing satellites and which is used to perform a satellite frequency search, fluctuates. Further, accompanying the fluctuation in this satellite search reference frequency fₛ, search target frequency 21 shown by the hatching portion in FIG. 3 shifts downward and the search range A also shifts. Therefore, there is no point where the frequency f₀ of a satellite and search target frequency 21 cross, and this point is out of the search range and therefore a search is not possible. If the search range is simply set wide according to a conventional technique to solve that the search is not possible, the satellite frequency search takes a very long time.

That is, in a conventional signal capturing apparatus, when the GPS clock frequency fluctuates during a satellite search, the frequency (i.e. satellite search reference frequency fₛ) that serves as the reference for a frequency search fluctuates at the same time, and there is a problem that a satellite frequency search would take a longer time. In this case, a GPS signal cannot be captured for a long time, and only a frequency search is kept going on and on.

In view of the above, it is therefore an object of the present invention to provide a signal capturing apparatus and signal capturing method for optimizing a timing to correct the clock frequency in a receiving section of a signal capturing apparatus (for example, GPS receiving apparatus) during positioning to prevent a search omission, and reducing the time required for positioning.

Moreover, it is another object of the present invention to provide a signal capturing apparatus for preventing deterioration in frequency precision when the frequency is corrected and for reducing the time required for positioning.

### Means for Solving the Problem

The signal capturing apparatus according to the present invention employs a configuration which includes: a signal receiving section that searches for a signal which uses a predetermined clock signal as an operation clock and which is a target to capture; a reference clock signal generating section that generates a reference clock signal which serves as a reference for a frequency of the predetermined clock signal; a frequency comparing section that compares the frequency of the predetermined clock signal and a frequency of the reference clock signal; a reference clock precision estimating section that estimates precision of the reference clock signal; and a controlling section that controls correction of the frequency of the predetermined clock signal based on the reference clock signal when the precision of the reference clock signal estimated in the reference clock precision estimating section is equal to or greater than a predetermined threshold.

The signal capturing method according to the present invention includes: searching for a signal which uses a predetermined clock signal as an operation clock and which is a target to capture; comparing a frequency of a reference clock signal, which serves as a reference for the predetermined clock signal, and a frequency of the predetermined clock signal; estimating precision of the reference clock signal; and controlling correction of the frequency of the predetermined clock signal based on the reference clock signal when the estimated precision of the reference clock signal is equal to or greater than a predetermined threshold.

### ADVANTAGEOUS EFFECTS OF INVENTION

The present invention can optimize the timing to correct the clock frequency in the receiving section of the signal capturing apparatus (for example, GPS receiving apparatus) during positioning to prevent a search omission, and reduce the time required for positioning.

Moreover, the present invention can prevent deterioration in frequency precision when the frequency is corrected, and reduce the time required for positioning.

### BRIEF DESCRIPTION OF DRAWINGS

FIG. 1 shows a configuration of a communication system in which a conventional signal capturing system is used;

FIG. 2 illustrates an example of a conventional satellite search for GPS signals;

FIG. 3 illustrates an example of a conventional satellite search for GPS signals;

FIG. 4 is a flowchart showing satellite searching processing of a mobile telephone having a conventional signal capturing apparatus;

FIG. 5 shows a configuration of a communication system in which a signal capturing apparatus according to an embodiment of the present invention is used;

FIG. 6 is a flowchart showing satellite signal searching processing in a mobile telephone having the signal capturing apparatus according to the present embodiment;

FIG. 7 is a flowchart showing processing of deciding whether or not to correct the frequency in a correction timing determining section of the signal capturing apparatus according to the present embodiment;

FIG. 8 illustrates an example of characteristics of frequency error of a cellular clock in association with received quality RSSI of the cellular clock in the signal capturing apparatus according to the present embodiment;

FIG. 9 illustrates an example of characteristics of temperature fluctuation in a GPS clock in association with a lapse time in the signal capturing apparatus according to the present embodiment;

FIG. 10 illustrates an example of temperature characteristics of a GPS clock in association with a lapse time in the signal capturing apparatus according to the present embodiment;

FIG. 11 illustrates an example of characteristics of frequency fluctuation in a GPS clock in association with temperature fluctuation in the GPS clock in the signal capturing apparatus according to the present embodiment;

FIG. 12 illustrates an example of characteristics of a GPS clock frequency in association with the temperature of the GPS clock in the signal capturing apparatus according to the present embodiment;

FIG. 13 shows the relationship between received quality RSSI and frequency error of the cellular clock in the signal capturing apparatus according to the present embodiment;

FIG. 14 illustrates an example of frequency characteristics of a GPS clock in association with the temperature of the GPS clock in the signal capturing apparatus according to the present embodiment;

FIG. 15 shows the relationship between received quality RSSI and frequency error of the cellular clock in the signal capturing apparatus according to the present embodiment;

FIG. 16 illustrates an example of temperature characteristics of a GPS clock in association with a lapse time in the signal capturing apparatus according to the present embodiment;

FIG. 17 illustrates an example of characteristics of frequency fluctuation in the GPS clock in association with temperature fluctuation in the GPS clock in the signal capturing apparatus according to the present embodiment;

FIG. 18 illustrates a searching operation by a mobile telephone having the signal capturing apparatus according to the present embodiment;

FIG. 19 is a flowchart showing satellite signal searching processing by the mobile telephone having the signal capturing apparatus according to the present embodiment; and

FIG. 20 is a flowchart showing satellite signal searching processing by the mobile telephone having the signal capturing apparatus according to the present embodiment.

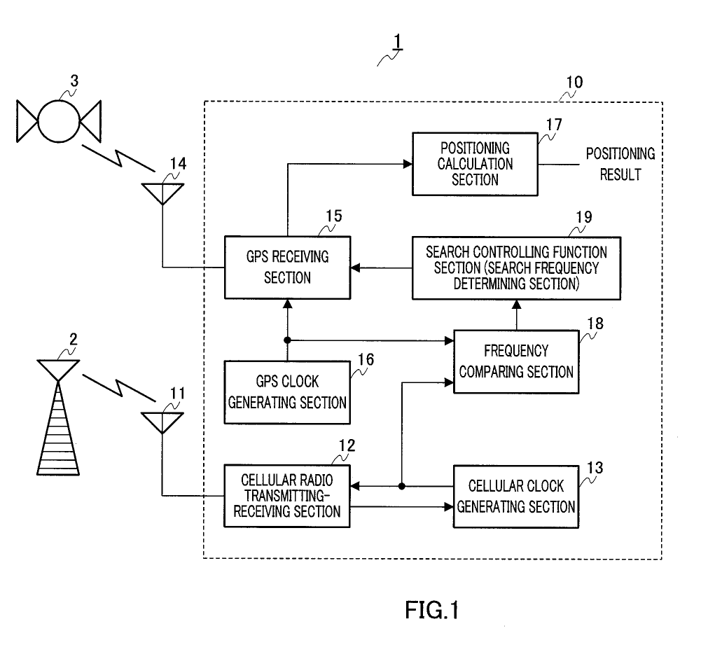

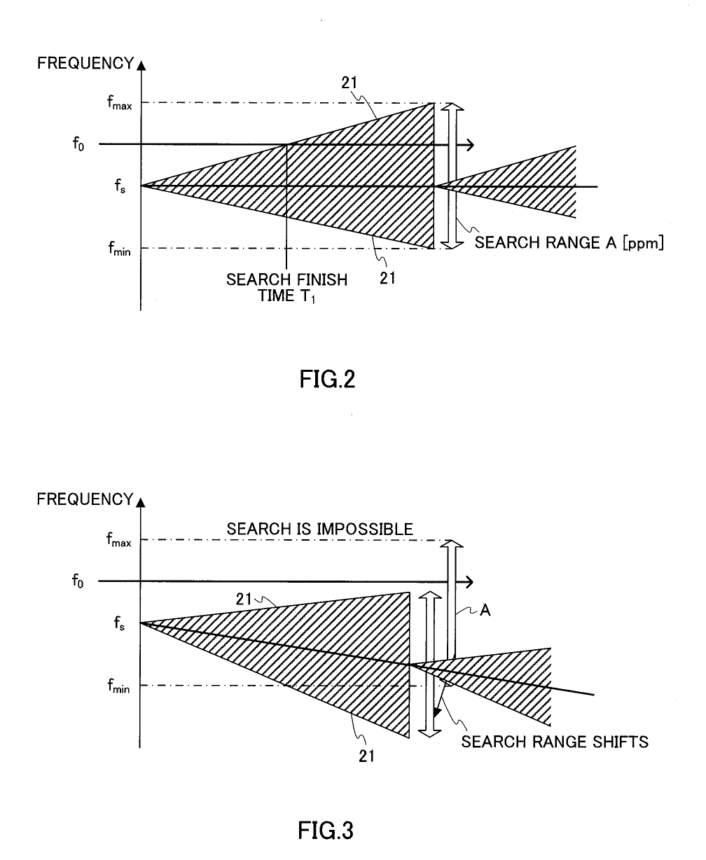

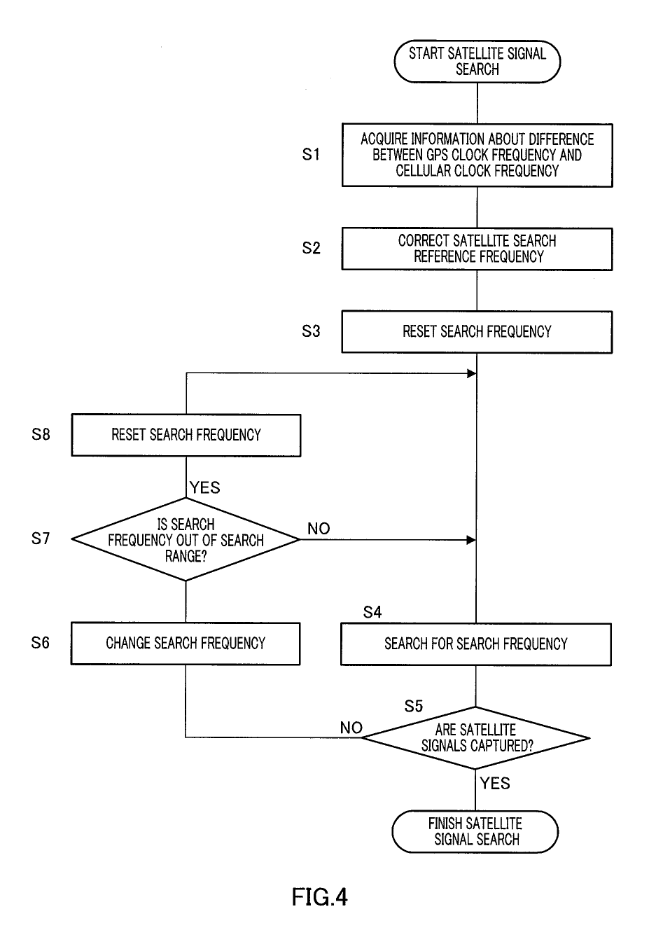

### BEST MODE FOR CARRYING OUT THE INVENTION

Hereinafter, the signal capturing apparatus according to an embodiment of the present invention will be explained in detail with reference to the accompanying drawings.

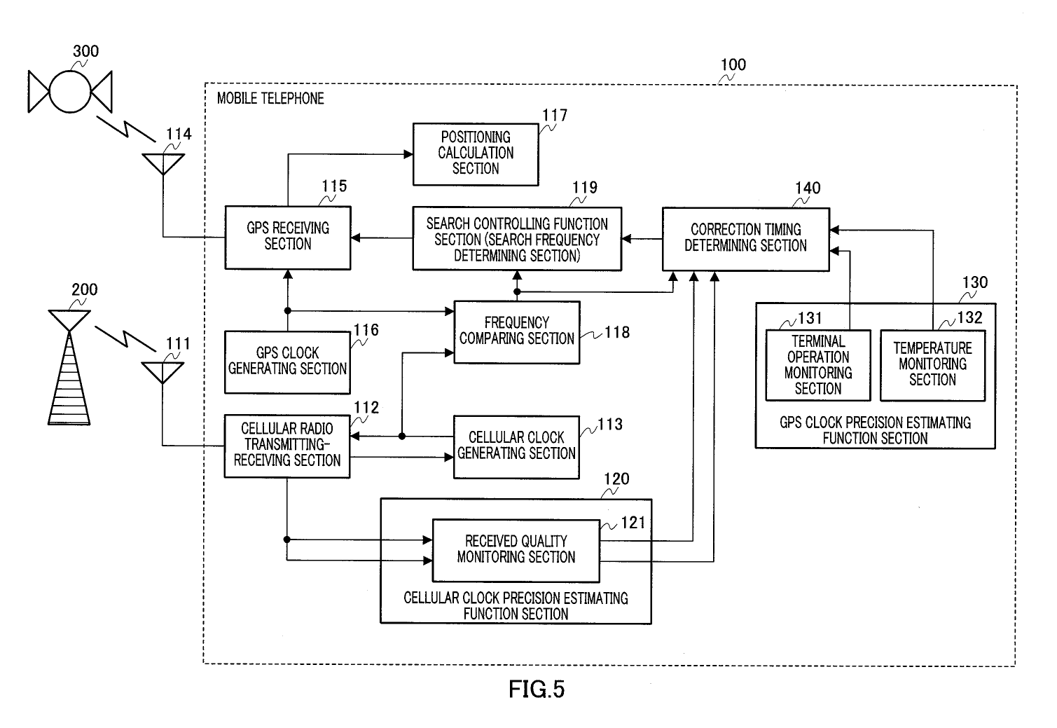

FIG. 5 shows a configuration of a communication system in which the signal capturing apparatus according to an embodiment of the present invention is used. The present embodiment is an example where the present invention is adopted to the GPS satellite positioning system as a signal capturing apparatus.

In FIG. 5, the communication system is mainly formed with: mobile telephone 100; radio base station 200; and GPS (e.g. SPS (solar power satellite)) satellite 300 (here, one GPS satellite out of one or more GPS satellites is shown) that is arranged in the sky above mobile telephone 100.

Mobile telephone 100 transmits and receives radio signals to and from radio base station 200 to communicate with another mobile telephone, fixed-line phone or information server (not shown). Further, mobile telephone 100 performs positioning by capturing GPS signals sent out from one or more GPS satellites 300 and extracting information from each GPS signal. Each GPS signal refers to a signal acquired by superimposing a carrier of the same frequency 1,57542 GHz with PRN code such as C/A code or P code that varies between satellites.

Mobile telephone 100 is constituted by radio antenna 111, cellular radio transmitting-receiving section 112, cellular clock generating section 113, GPS antenna 114, GPS receiving section 115, GPS clock generating section 116, positioning calculation section 117, frequency comparing section 118, cellular clock precision estimating function section 120, GPS clock precision estimating function section 130, and correction timing determining section 140. Cellular clock precision estimating function section 120 is constituted by received quality monitoring section 121. GPS clock precision estimating function section 130 is constituted by terminal operation monitoring section 131 and temperature monitoring section 132.

Mobile telephone 100 refers to a mobile communication terminal that has the function of establishing connection with radio base station 200 and the positioning function using a GPS system, and is configured by a CPU (not shown), a storing medium that stores a control program such as a ROM, a working memory such as a RAM and a communication circuit as existing hardware. In mobile telephone 100, the function of each above-described section is implemented by executing the control program on the CPU.

Cellular radio transmitting-receiving section 112 transmits and receives radio signals to and from radio base station 200, and establishes frequency synchronization with the base station to communicate with, to improve precision of cellular clocks. Radio base station 200 has a clock oscillator that generates clock signals at high frequency precision. Then, radio base station 200 generates carrier frequencies from these clock signals to perform radio communication with cellular radio transmitting-receiving section 112. Cellular radio transmitting-receiving section 112 has an AFC apparatus with a PLL circuit (not shown), and establishes frequency synchronization between the carrier frequencies of radio signals sent out from radio base station 200 to make cellular clocks generated in cellular clock generating section 113 more precise.

GPS receiving section 115 searches for and captures GPS signals and acquires information included in these GPS signals. Then, positioning calculation section 117 performs calculation based on the acquired information to perform positioning. To be more specific, GPS receiving section 115 performs a satellite search for the satellites of the GPS signals inputted from GPS antenna 114 based on the search frequency set in search controlling function section 119, and establishes code synchronization. GPS receiving section 115 has a plurality of channels that perform the same operation.

GPS clock generating section 116 supplies clock signals for operating the GPS receiving section. GPS clock generating section 116 generates GPS clock signals used as operation clocks of GPS receiving section 115 by using a temperature compensated crystal oscillator (TCXO, not shown). GPS clock generating section 116 does not establish frequency synchronization as in the AFC apparatus in cellular radio transmitting-receiving section 112 of mobile telephone 100, and is the automatic source that generates clocks. Further, although a temperature compensated type crystal oscillator is used, the oscillation frequency of the crystal oscillator fluctuates due to the influence of the temperature of the surroundings. Therefore, frequency precision of the GPS clock signal is lower than frequency precision of the reference clock signal of cellular radio transmitting-receiving section 112 that establishes frequency synchronization with radio base station 200.

Positioning calculation section 117 performs positioning calculation based on satellite capture information of a plurality of channels such as the code phases, frequencies and signal levels of the time when code synchronization is established in GPS receiving section 115, and outputs a positioning result.

Frequency comparing section 118 outputs information about the difference between the GPS clock frequency and the cellular clock frequency. Frequency comparing section 118 has the frequency correction controlling function for outputting information about the difference between the GPS clock frequency and the cellular clock frequency.

Search controlling function section 119 determines the center frequency for performing a satellite search (i.e. search reference frequency) based on information about the frequency difference from frequency comparing section 118. The frequencies that are used to search for satellites are sequentially set based on the search reference frequency. The number of frequencies to be searched for is set to the number of channels which GPS receiving section 115 can search at the same time. The frequency to be searched for is changed until code synchronization in each channel is established in GPS receiving section 115.

Received quality monitoring section 121 detects received quality in radio communication (RSSI (Received Signal Strength Indicator), BER (Bit Error Rate), BLER (Block Error Rate), Ec/N0 (Signal Energy per chip over Noise Power Spectral Density), S/N (Signal to Noise ratio), C/N (Carrier to Noise ratio), the number of antenna bars and so on).

Terminal operation monitoring section 131 monitors the state of the operation of the terminal that influences frequency fluctuation in the GPS clock. Temperature monitoring section 132 is formed with a temperature sensor and so on, and monitors fluctuation in the temperature of the terminal that influences frequency fluctuation in the GPS clock. For example, the TCXO is used to generate GPS clocks. Although the TCXO is a temperature compensation type crystal oscillator, the oscillation frequency fluctuates due to the influence by the temperature of the surroundings. Then, temperature monitoring section 132 monitors the temperature of the surroundings of the TCXO. Further, terminal operation monitoring section 131 estimates temperature fluctuation based on the operation of the terminal.

Correction timing determining section 140 estimates, for example, frequency fluctuation in the GPS clock and frequency precision of the cellular clock during positioning, decides whether or not the GPS clock frequency needs to be corrected, and determines whether or not to correct the frequency. In the configuration where GPS clocks are corrected intermittently based on the cellular clock during the operation of GPS positioning (i.e. satellite search), correction timing determining section 140 detects received quality in radio communication (RSSI (Received Signal Strength Indicator), BER (Bit Error Rate), BLER (Block Error Rate), Ec/N0, S/N, C/N, the number of antenna bars and so on) and decides whether or not to correct the frequency, based on a result of comparing received quality and a threshold. Here, the state where received quality is high and the state where received quality is low match the state where an estimated value of precision of the cellular clock is high and the state where an estimated value of precision of the cellular clock is low, respectively. To be more specific, whether or not to correct the frequency is decided according to following (1) to (3).

(1) When received quality of signals from a base station during communication is compared with a threshold, if received quality is higher or lower than the threshold, whether or not to correct the frequency is decided.

(2) When the average value of received quality of signals from a plurality of base stations is calculated and compared with the threshold, if this average value is higher or lower than the threshold, whether or not to correct the frequency is decided.

(3) When the current received quality is compared with received quality upon previous timing by storing received quality upon the previous timing the frequency is corrected (here, the weighted average of past several received qualities may also be used), if the current received quality is better or poorer than past received quality, whether or not to correct the frequency is decided.

The above threshold is set according to the estimated value of frequency fluctuation in the GPS clock. For example, when the estimated value of frequency fluctuation in the GPS clock is great, the threshold for received quality is made small. Further, the estimated value of frequency fluctuation is estimated based on the lapse time of positioning, the lapse time of the operation of the terminal, the result of comparing the frequency difference and so on.

Furthermore, correction timing determining section 140 can determine the timing to correct the frequency of a signal during positioning, using handover information.

Correction timing determining section 140 determines the timing to correct the frequency during the GPS positioning operation (i.e. satellite search), based on handover information in radio communication. To be more specific, whether or not to correct the frequency is decided according to following (4) and (5).

How often the frequency is corrected is determined based on whether or not handover is performed. Upon handover, it is estimated that frequency fluctuation in the cellular clock occurs.

(5) How often (less often or more often) the frequency is corrected is determined based on whether or not the number of times handover is performed (the number of times/unit time) is greater or less than a predetermined threshold. The moving speed is decided based on the number of times handover is performed.

How often the frequency is corrected is set based on the estimated value of frequency fluctuation in the GPS clock. For example, when the estimated value of frequency fluctuation in the GPS clock is greater, the threshold of the number of times handover is performed is made greater. Further, the estimated value of frequency fluctuation is estimated based on the lapse time of positioning, the lapse time of the operation of the terminal, the result of comparing frequency difference and so on.

The operation of mobile telephone 100 having the signal capturing apparatus constituted as described above will be explained below.

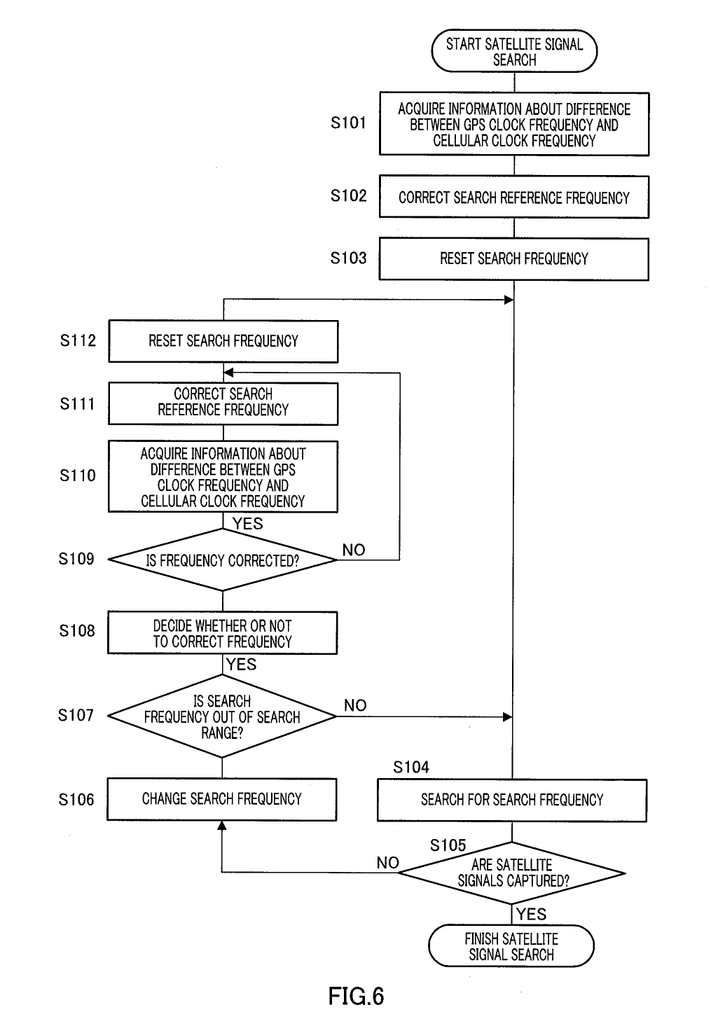

FIG. 6 is a flowchart showing satellite signal searching processing in mobile telephone 100 having the signal capturing apparatus.

First, in step S101, frequency comparing section 118 acquires information about the difference between the GPS clock frequency and the cellular clock frequency. The clock frequency difference can be determined by counting how many times a GPS clock signal rises in a period in which, for example, a reference clock signal rises, and comparing the actual count value and the count value acquired when the GPS clock frequency is an ideal value.

In step S102, search controlling function section 119 corrects the satellite search reference frequency fₛ based on the acquired information about the frequency difference.

In step S103, search controlling function section 119 resets the search frequency once and, in step S104, searches for the search frequency.

In step S105, whether or not a satellite signal is successfully captured is decided and, if the satellite signal is successfully captured, it is decided that a search for the satellite signal is finished and this flow is finished. The search for GPS signals is finished, for example, when code synchronization is established between a number of GPS satellites 300 that are required for positioning or when code synchronization cannot be established between a number of GPS satellites 300 that are required for positioning even though a search is performed in a predetermined search range (explained later).

If a satellite signal is not captured successfully, the search frequency is changed in step S106 and whether or not the search frequency is out of the search range is decided in step S107. If the search frequency is out of the search range, the flow proceeds to step S108 for deciding whether or not to correct the frequency. Further, if the search frequency is not out of the search range, the flow proceeds to step S104 as is and the search frequency is searched for in step S104.

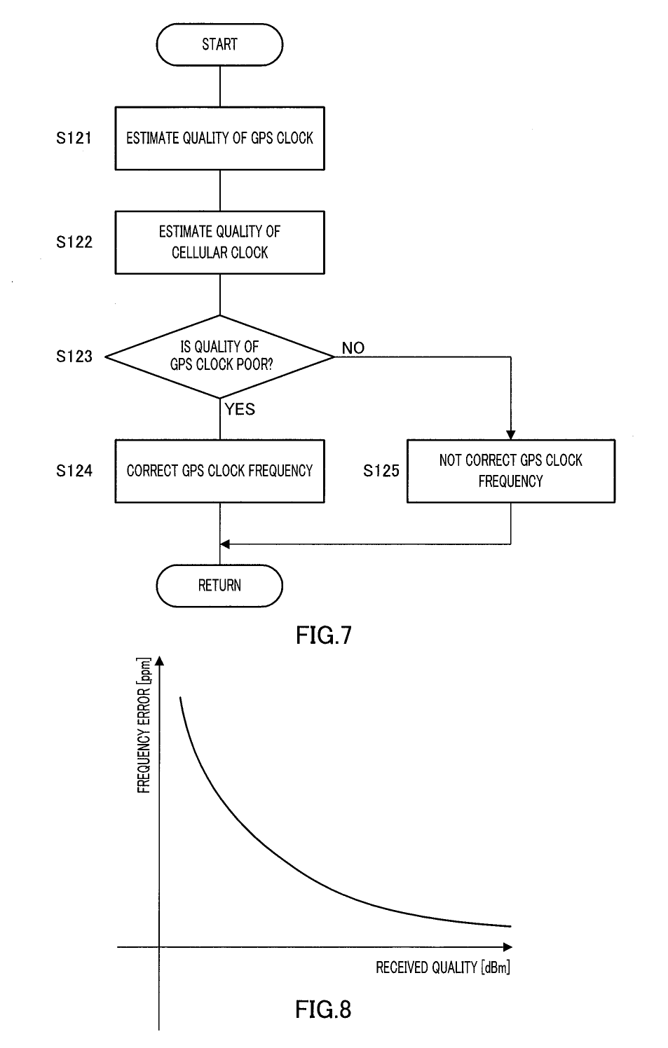

Correction timing determining section 140 decides whether or not to correct the frequency in step S108, and, in step S109, branches processing depending on a result of deciding whether or not to correct the frequency in step S108. The method of deciding whether or not to correct the frequency will be described later with reference to the flowchart in FIG. 7 and FIG. 13 to FIG. 16.

If the frequency is not corrected in above step S109, the flow proceeds to step S112 as is, the search frequency is reset in step S112 and then the flow proceeds to step S104.

By contrast with this, if the frequency is corrected in above step S109, frequency comparing section 108 acquires information about the difference between the GPS clock frequency and the cellular clock frequency in step S110. In step S111, search controlling function section 119 corrects the center frequency for performing a satellite search (i.e. search reference frequency) based on information about the frequency difference from frequency comparing section 118, and the flow proceeds to step S112. The search frequency is reset in step S112, and the flow proceeds to step S104. The number of frequencies to be searched for is set to the number of channels which GPS receiving section 115 can search at the same time. GPS receiving section 115 repeats the searching operation by changing the frequency to be searched for, according to the above searching processing until code synchronization in each channel is finished.

Correction timing determining section 140 decides whether or not the GPS clock frequency needs to be corrected based on information about frequency precision of the GPS clock acquired in GPS clock precision estimating function section 130 and information about frequency precision of the cellular clock acquired in cellular clock precision estimating function section 120, and outputs a search frequency reset signal when the frequency is corrected or when the search frequency is out of the search range.

FIG. 7 is a flowchart showing processing of correction timing determining section 140 to decide whether or not to correct the frequency. This flow shows the flow of step S108 in FIG. 6 in more detail.

In step S121, quality of the GPS clock is estimated. The quality of the GPS clock is estimated according to following (1) or (2).

(1) When temperature fluctuation is more significant, the quality indicator is poorer.

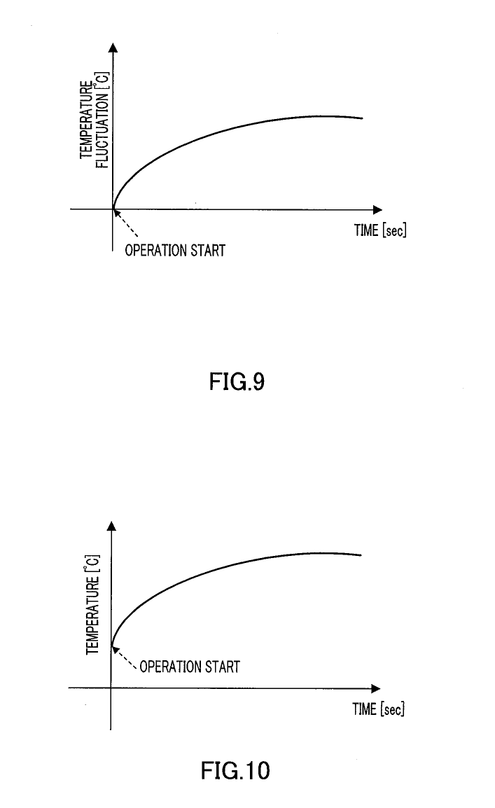

(2) When the change (the change of CPU operating ratio (what percent the CPU operation occupies)) of the operating state of a terminal (FOMA (registered trademark) transmission, GPS operation and so on) is more significant, the quality indicator is poorer. Further, when the lapse time after the operating state changes is shorter, the quality indicator is poorer. After a certain period passes, the temperature becomes stable. The method of estimating frequency precision of the GPS clock will be described with reference to FIG. 9 to FIG. 12.

In step S122, quality of the cellular clock is estimated. The quality of the cellular clock is estimated as follows.

When the RSSI (Received Signal Strength Indicator) value is smaller, the quality indicator is poorer. The method of estimating frequency precision of the cellular clock will be described with reference to FIG. 8. Further, in addition to RSSI, quality of cellular clocks is estimated based on BER (Bit Error Rate), BLER (Block Error Rate), Ec/N0, S/N, C/N, the number of antenna bars and so on.

In step S123, quality of the GPS clock and quality of the cellular clock are compared and whether or not quality of the GPS clock is poorer than quality of the cellular clock is decided. If the quality of the GPS clock is poorer than the quality of the cellular clock, it is decided in step S124 that the GPS clock frequency is corrected and the flow returns to step S109 in FIG. 6. If the quality of the GPS clock is not poorer than the quality of the cellular clock, it is decided in step S125 that the GPS clock frequency is not corrected and the flow returns to step S109 in FIG. 9.

Next, the method of deciding frequency precision of the cellular clock and frequency precision of the GPS clock will be explained.

[Method of Deciding Frequency Precision of the Cellular Clock]

FIG. 8 shows the relationship between received quality RSSI [dBm] and frequency error [ppm] of the cellular clock. As shown in FIG. 8, the relationship between received quality RSSI [dBm] and frequency error [ppm] of the cellular clock is inversely proportional. Generally, frequency synchronization by AFC refers to comparing the phase of a received signal and the phase of a cellular clock and controlling the cellular clock such that the phase difference becomes zero. At this time, if received quality RSSI is low, noise enters phase information acquired from the received signal, and therefore precision of frequency synchronization decreases and, as a result, frequency precision decreases.

[Method of Deciding Frequency Precision of the GPS Clock]

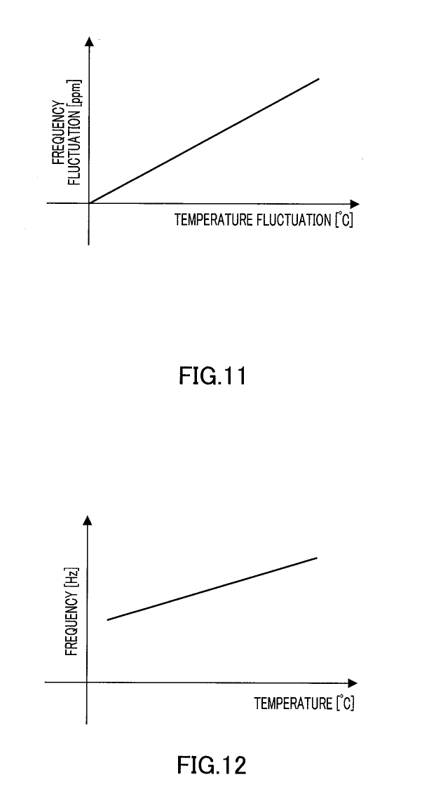

FIG. 9 to FIG. 12 show the relationships between the lapse time and temperature fluctuation in the GPS clock or frequency fluctuation in the GPS clock. FIG. 9 shows characteristics of temperature fluctuation [° C.] in association with the lapse time, FIG. 10 shows characteristics of the temperature [° C.] in association with the lapse time, FIG. 11 shows characteristics of frequency fluctuation [ppm] in association with temperature fluctuation [° C.] and FIG. 12 shows frequency characteristics [Hz] in association with the temperature [° C.].

GPS clock generating section 116 does not establish frequency synchronization as in the AFC apparatus in cellular radio transmitting-receiving section 112 of mobile telephone 100, and is the automatic source that generates clocks. Further, although the temperature compensated type crystal oscillator is used, the oscillation frequency of the crystal oscillator fluctuates due to the influence of the temperature of the surroundings. Therefore, frequency precision of the GPS clock signal is lower than frequency precision of the reference clock signal of cellular radio transmitting-receiving section 112 that establishes frequency synchronization with radio base station 200.

Although, for example, the TCXO is used to generate GPS clocks, the frequency of the TCXO fluctuates particularly due to temperature fluctuation. (1) There is a method of estimating characteristics of the temperature and temperature fluctuation in association with the lapse time by monitoring using the temperature sensor and so on or by estimating temperature fluctuation based on the operation of the terminal. Furthermore, (2) there is a method of estimating frequency precision and frequency fluctuation based on information about frequency precision in association with the temperature of the TCXO and information about frequency precision fluctuation in association with temperature fluctuation.

Next, the method of comparing frequency precision of the cellular clock and frequency precision of the GPS clock will be explained. As described above, different decision conditions are applied to frequency precision of the cellular clock and frequency precision of the GPS clock. Therefore, it is necessary to use parameters correlated with both to compare both frequency precisions. “A method of estimating frequency precision of the GPS clock based on the temperature” and “a method of estimating frequency fluctuation in the GPS clock based on temperature fluctuation” will be explained as steps of comparing frequency precision of the cellular clock and frequency precision of the GPS clock.

[Step 1 of Comparing Frequency Precisions (A Method of Estimating Frequency Precision of the GPS Clock Based on the Temperature)]

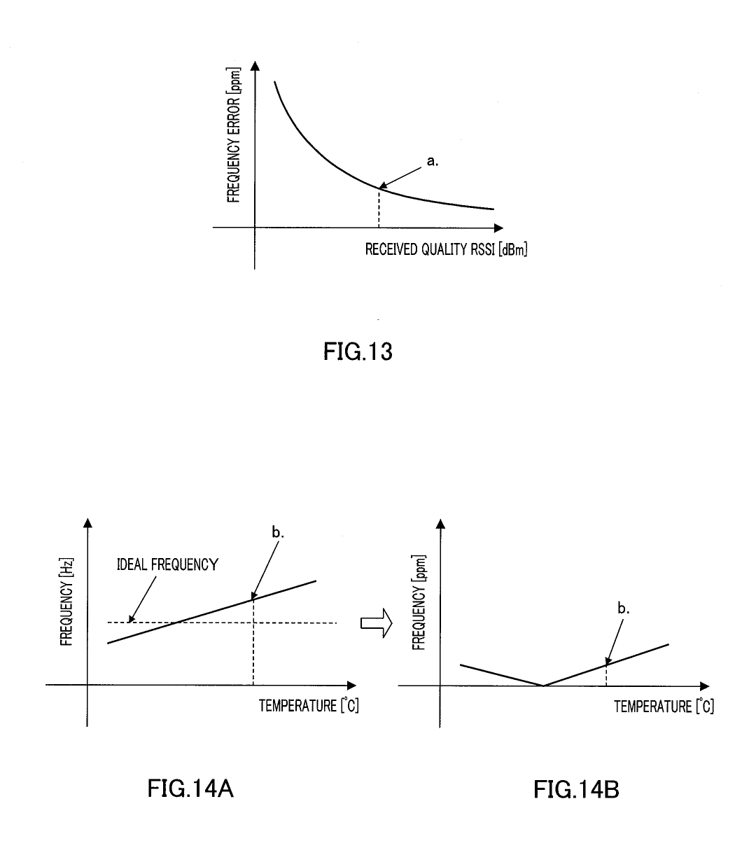

FIG. 13 shows the relationship between received quality RSSI [dBm] and frequency error [ppm] of a cellular clock, and FIG. 14A and FIG. 14B show the relationship between the temperature [° C.] and frequency [Hz] and frequency error [ppm] of a GPS clock. FIG. 14B shows a shift of the frequency in FIG. 14A from the ideal frequency (i.e. frequency error).

(1) The frequency error of the cellular clock is estimated based on received quality RSSI. The frequency error of the cellular clock at “a.” in FIG. 13 is estimated.

(2) The frequency error of the GPS clock is estimated based on the temperature. The frequency error of the GPS clock at “b.” in FIG. 14 is estimated.

(3) Upon comparison of the results of above (1) and (2), if a<b holds, the frequency is corrected.

Further, above (1) to (3) are performed at the timing the frequency is corrected.

[Step 2 of Comparing Frequency Precisions (A Method of Estimating Frequency Fluctuation in the GPS Clock Based on Temperature Fluctuation)]

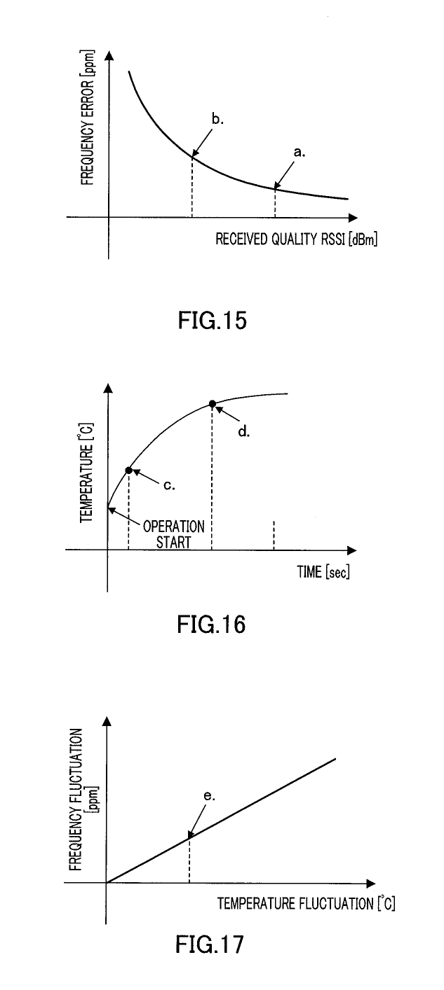

FIG. 15 shows the relationship between received quality RSSI [dBm] and frequency error [ppm] of the cellular clock, FIG. 16 shows the temperature characteristics [° C.] of the GPS clock in association with the lapse time and FIG. 17 shows the relationship between temperature fluctuation [° C.] and frequency fluctuation [ppm] of the GPS clock.

(1) The frequency error of the cellular clock is estimated based on received quality RSSI when the positioning operation starts to correct the frequency. The frequency error of the cellular clock at “a.” in FIG. 15 is estimated to correct the frequency.

(2) The temperature [° C.] of the GPS clock of the time when the positioning operation is started and the frequency is corrected, is estimated. The temperature of the GPS clock at “c.” in FIG. 16 is estimated.

(3) At the timing the frequency is corrected, frequency error of the cellular clock is estimated based on received quality RSSI. The frequency error of the cellular clock at “b.” in FIG. 15 is estimated.

(4) At the timing the frequency is corrected, the temperature [° C.] of the GPS clock is estimated to estimate how the temperature has fluctuated since the previous correction. The temperature of the GPS clock at “d.” in FIG. 16 is estimated and is compared with the temperature of the GPS clock upon the previous correction (here, c was estimated at the first time) to estimate how the temperature has fluctuated.

(5) Frequency fluctuation in the GPS clock is estimated based on temperature fluctuation estimated as described above. The frequency fluctuation in the GPS clock at “e.” in FIG. 17 is estimated.

(6) Upon comparison of the results of frequency precisions b and e (here, a was estimated at the first time) of the cellular clock upon the previous correction, if “b<frequency precision of the cellular clock upon the previous correction (the first time is a)+e” holds, the frequency is corrected.

(7) Above (3) to (6) are executed repeatedly.

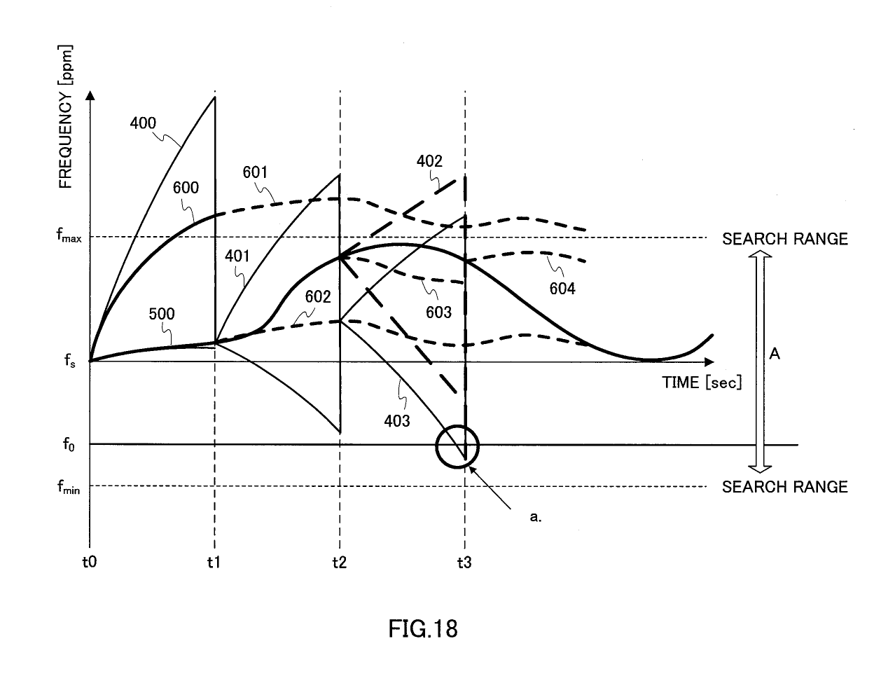

FIG. 18 illustrates the searching operation by mobile telephone 100 having the signal capturing apparatus according to the present embodiment. In FIG. 18, the horizontal axis represents the lapse time [sec] after the search is started, and the vertical axis represents the frequency [ppm]. fₛ in the frequency domain is the search start frequency, and f₀ is the true frequency of a satellite to be searched for. The true frequency f₀ of the satellite is positioned away from the search start frequency fₛ, and the mobile communication terminal (i.e. mobile telephone 100) performs a search by shifting search target frequency 400 gradually to the surrounding frequency bands over time based on search start frequency fₛ. When the search range is widened, the time required for a search increases accordingly, and therefore the value of the frequency upper limit fₘₐₓ and the value of the frequency lower limit fₘᵢₙ are generally set to search target frequency 400. Then, by shifting search target frequency 400 to its upper limit value and lower limit value at a speed such that search target frequency 400 reaches its upper limit value and lower limit value in a predetermined time, it is possible to finish a search in a predetermined period in the set search range A, that is, in the frequency band between the value of the frequency upper limit fₘₐₓ and the value of frequency lower limit fₘᵢₙ. Here, even if the GPS signal cannot be captured after the search is finished, a series of searching processing described in step S105 to step S112 in FIG. 6 are executed again. Search target frequencies 401 to 403 refer to the search target frequencies in case where searching processing is executed again.

The search start frequency fₛ refers to the center frequency for capturing satellites and is used as the center frequency for capturing satellites to start a search, and, after the search is started, GPS clock frequency 600 is corrected based on cellular clock frequency 500. GPS clock frequency 600 is corrected based on cellular clock frequency 500 as the center frequency for capturing satellites to perform the next searching processing.

GPS clock frequency 600 shown by the solid line in FIG. 18 shows fluctuation from time tₒ GPS clock frequency 600 is corrected based on cellular clock frequency 500 to time tᵢ a search in the search range A is finished.

GPS clock frequency 601 shown by the broken line in FIG. 18 refers to the GPS clock frequency that is not corrected at first time t₁ based on cellular clock frequency 500. Further, GPS clock frequency 602 refers to the GPS clock frequency that is corrected at first time t₁ based on cellular clock frequency 500. Furthermore, GPS clock frequency 603 refers to the GPS clock frequency that is corrected at second time t₂ based on cellular clock frequency 500. Still further, GPS clock frequency 604 refers to the GPS clock frequency that is corrected at third time t₃ based on cellular clock frequency 500.

Moreover, search target frequency 400 refers to the search target frequency that originates from GPS clock frequency 600 starting from the search start frequency fₛ. Further, search target frequency 401 refers to the search target frequency that originates from GPS clock frequency 601 corrected at first time t₁ based on GPS clock frequency 500. Furthermore, search target frequency 402 refers to the search target frequency that originates from GPS clock frequency 601 corrected at second time t₂ based on GPS clock frequency 500. Still further, search target frequency 403 refers to the search target frequency in case where search target frequency 403 is not corrected at third time t₃ based on cellular clock frequency 500, that is, in case where GPS clock frequency 602 at second time t₂ is used as is as the search reference frequency.

Generally, the cellular clock has good precision, and therefore the GPS clock frequency is corrected based on a cellular clock. With a conventional example, the GPS clock frequency is corrected at all times based on the cellular clock. However, in case where precision of cellular clock frequency 500 is poorer, if the GPS clock frequency is corrected based on the cellular clock frequency, there is a possibility that frequency precision becomes poorer as a result and it takes more time to capture a satellite. With the present embodiment, if precision of a cellular clock is poorer, the GPS clock frequency is not corrected based on the cellular clock frequency and, consequently, it is possible to finish capturing of a satellite.

With the present embodiment, frequency precision of the cellular clock is decided according to the above [method of deciding frequency precision of the cellular clock]. Further, frequency precision of the cellular clock is estimated in step S122 of the flowchart in FIG. 7 utilizing the fact that, when an RSSI value is smaller, the received quality indicator is poorer. Furthermore, in addition to RSSI, frequency precision may be estimated based on BER (Bit Error Rate), BLER (Block Error Rate), Ec/N0, S/N, C/N, the number of antenna bars and so on. While the GPS clock frequency is corrected based on the cellular clock frequency if precision of cellular clock frequency 500 is good, the GPS clock frequency is not corrected based on the cellular clock frequency if precision of a cellular clock is poorer. In FIG. 18, precision of cellular clock frequency 500 is poorer in the vicinity from second time t₂ to third time t₃. Therefore, in a region where frequency precision is poorer in the vicinity from second time t₂ to third time t₃, the GPS clock frequency is not corrected based on cellular clock frequency 500. In this case, search target frequency 403 is determined at third time t₃ based on GPS clock frequency 602 at second time t₂, without depending on cellular clock frequency 500.

With a conventional example, assuming that the cellular clock has better precision than the GPS clock at all times, the GPS clock frequency is corrected based on the cellular clock at all times. In FIG. 18, the example is search target frequency 402 that originates from GPS clock frequency 601 corrected at second time t₂ based on cellular clock frequency 500. In case where the GPS clock frequency is corrected based on cellular clock frequency 500 having poorer frequency precision, the search range of search target frequency 402 (see the broken line triangle in FIG. 18) is substantially far from the true frequency fₒ for searching for a satellite and there is no possibility that the true frequency fₒ is captured based on search target frequency 402. By contrast with this, with the present embodiment, the GPS clock frequency is not corrected based on cellular clock frequency 500 in a region where frequency precision is poorer. Thanks to a search based on search target frequency 403 (see the solid line triangle in FIG. 18) that originates from GPS clock frequency 602 at second time t₂, the origin is shifted toward the higher frequency side and lower frequency side over time. If search target frequency 403 reaches the true frequency f₀ of a satellite to search for immediately before third time t₃ (see “a.” in FIG. 18), satellite signals are successfully captured and a search is finished.

As explained above, the present embodiment estimates received quality in radio communication by cellular clock precision estimating function section 120. Further, correction timing determining section 140 corrects the GPS clock frequency based on the cellular clock if estimated received quality is equal to or better than a predetermined threshold, and does not correct the GPS clock frequency based on the cellular clock if received quality is poorer than a threshold. By this means, it is possible to optimize the timing to correct the GPS clock frequency during positioning, prevents a search omission and reduce the time required for positioning.

Moreover, it is possible to prevent deterioration in frequency precision when the frequency is corrected and reduce the time required for positioning.

Furthermore, correction timing determining section 140 can prevent deterioration in frequency precision when the frequency is corrected and reduce the time required for positioning, by using handover information.

The difference between the present embodiment and a conventional example will be explained. In response to a problem that performance of positioning deteriorates if the GPS clock frequency fluctuates (here, the main factor is temperature fluctuation) during the positioning operation (i.e. satellite search), a method may be possible according to a conventional example for (1) correcting the GPS clock frequencies based on cellular clocks intermittently and (2) deciding precision of a cellular clock based on received quality in radio communication to correct the frequency and prevent deterioration in performance of positioning.

However, the method of this conventional example (3) performs an unnecessary operation of correcting the frequency in case where quality of a cellular clock is good and quality of a GPS clock is much better than the cellular clock or (4) does not perform the necessary operation of correcting the frequency in case where quality of a cellular clock is poorer and quality of a GPS clock is much poorer than the cellular clock, and therefore has a problem of deteriorating performance of positioning.

By contrast with this, the timing to correct the frequency is determined as follows with the present embodiment. a. Frequency fluctuation in the GPS clock is estimated. b. The threshold of received quality in cellular radio transmitting-receiving section 112 is fluctuated according to the estimated value of frequency fluctuation in the GPS clock. c. Correction timing determining section 140 compares the threshold for received quality of cellular radio transmitting-receiving section 112 and received quality in cellular radio transmitting-receiving section 112 to decide the timing to correct the frequency. In this way, with the present embodiment, the timing to correct the frequency is decided taking into account both qualities of the GPS clock and cellular clock and, consequently, the frequency is not corrected unnecessarily or the frequency that needs to be corrected is corrected without fail as described in above (3) and (4), so that it is possible to optimize the timing to correct the frequency and improve performance of positioning.

The above explanation is an illustration of a preferable embodiment of the present invention and the scope of the present invention is not limited to this.

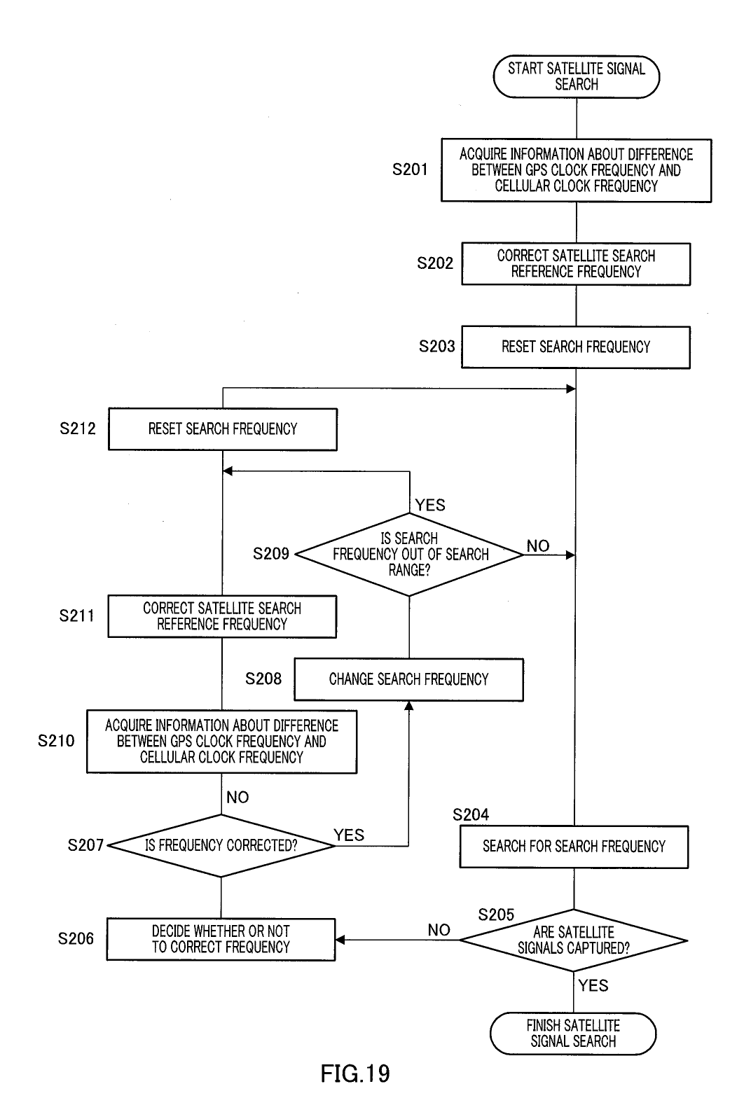

For example, although whether or not to correct the frequency is decided to perform correction when the search frequency goes out of the search range, to perform correction in the flowchart of searching processing in FIG. 6, as shown in FIG. 19, whether or not to correct the frequency may be decided to perform or not to perform correction every time the search frequency is changed and the search frequency is searched for.

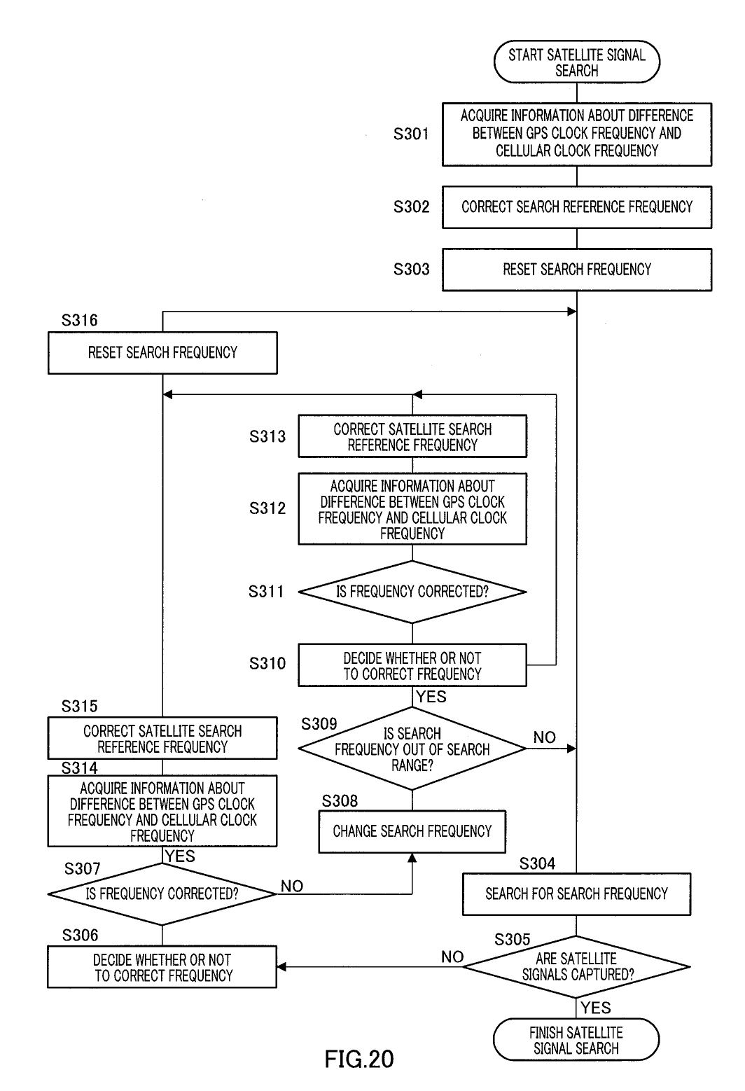

Further, as shown in FIG. 20, at both timings when (1) the search frequency goes out of the search range and (2) the search frequency is changed and the search frequency is searched for, whether or not to correct the frequency may be decided to perform or not to perform correction. In this case, the threshold of received quality in cellular radio transmitting-receiving section 112 which serves as a criterion to decide whether or not to correct the frequency in (1) and (2) may be set separately.

By performing satellite searching processing as described above, it is possible to set fine timings to correct the frequency and further optimize the timing to correct the frequency.

Further, although GPS clock precision estimating function section 130 is configured by both terminal operation monitoring section 131 and temperature monitoring section 132 as shown in FIG. 5, GPS clock precision estimating function section 130 may be configured by only terminal operation monitoring section 131 or only temperature monitoring section 132

Furthermore, for example, although a clock signal that is used to communicate with a radio base station as a target to be compared with a GPS clock signal, is used as a reference clock signal, other clock signals may be used. Still further, in case where a GPS signal is successfully captured in a given channel, a clock signal that is acquired when it synchronizes with the carrier frequency of the GPS signal, may be used as a reference clock signal to perform a search in other channels.

Although a case has been explained above where the present invention is applied to a mobile telephone having a GPS function, the present invention is not limited to this, and it naturally follows that the present invention can be applied to various other apparatuses that try to capture signals of a predetermined frequency using clock signals of frequencies that are likely to fluctuate.

Further, although the names “signal capturing apparatus” and “signal capturing method” are used with the present embodiment for ease of explanation, it naturally follows that these names may be “positioning system” and “receiving apparatus.”

Furthermore, each circuit section constituting the above signal capturing apparatus, types of positioning calculation section, the number of positioning calculation sections, the connection method thereof and types of a radio communication are not limited to the above-described embodiment.

### INDUSTRIAL APPLICABILITY

The present invention is suitable for use in signal capturing apparatuses (for example, mobile communication terminals) having functions to capture signals sent out from positioning satellites (for example, GPS satellites).

1. A signal capturing apparatus comprising:
a signal receiving section that searches for a signal which uses a predetermined clock signal as an operation clock and which is a target to capture;
a reference clock signal generating section that generates a reference clock signal which serves as a reference for a frequency of the predetermined clock signal;
a frequency comparing section that compares the frequency of the predetermined clock signal and a frequency of the reference clock signal;
a reference clock precision estimating section that estimates precision of the reference clock signal; and
a controlling section that controls correction of the frequency of the predetermined clock signal based on the reference clock signal when the precision of the reference clock signal estimated in the reference clock precision estimating section is equal to or greater than a predetermined threshold.

2. The signal capturing apparatus according to claim 1, further comprising:
a radio communication section that uses a radio communication clock signal for the reference clock signal generating section as the operation clock; and
a received quality estimating section that serves as the reference clock precision estimating section to estimate received quality in the radio communication section, wherein:
the frequency comparing section compares the frequency of the predetermined clock signal and a frequency of the radio communication clock signal; and
the controlling section controls the correction of the frequency of the predetermined clock signal based on the radio communication clock signal when received quality estimated in the received quality estimating section is equal to or greater than the predetermined threshold.

3. The signal capturing apparatus according to claim 2, wherein the received quality estimating section estimates the received quality by detecting one of a received signal strength indicator, a signal energy per chip over noise power spectral density, a bit error rate, a block error rate, signal to noise ratio, a carrier to noise ratio and a number of antenna bars.

4. The signal capturing apparatus according to claim 2, wherein the received quality estimating section estimates frequency fluctuation in the predetermined clock signal and changes the threshold for the received quality in the radio communication section according to an estimated value of one of frequency precision and frequency fluctuation in the predetermined clock signal.

5. The signal capturing apparatus according to claim 2, further comprising a temperature detecting section that detects a temperature in a predetermined location in the signal capturing apparatus,
wherein the received quality estimating section determines an estimated value of frequency precision and frequency fluctuation in the predetermined clock signal based on the temperature detected in the temperature detecting section.

6. The signal capturing apparatus according to claim 2, further comprising a various operating state monitoring section that monitors various operating states of the signal capturing apparatus,
wherein the received quality estimating section determines an estimated value of one of frequency precision and fluctuation in the predetermined clock signal frequency based on information about changes in the various operating states and a lapse time of the various operating states, the information being acquired from the various operating state monitoring section.

7. The signal capturing apparatus according to claim 2, wherein the received quality estimating section determines an estimated value of one of frequency precision and fluctuation in the predetermined clock signal frequency based on a result of comparing the frequency of the radio communication clock and the frequency of the predetermined clock signal.

8. The signal capturing apparatus according to claim 2, wherein the controlling section does not allow the correction of the frequency of the predetermined clock signal based on the radio communication clock signal when the received quality is lower than the predetermined threshold.

9. The signal capturing apparatus according to claim 1, wherein the controlling section makes the threshold small when an estimated value of frequency fluctuation in the predetermined clock signal is greater than a predetermined value.

10. The signal capturing apparatus according to claim 1, wherein the controlling section controls the correction of the frequency based on handover information in radio communication.

11. A signal capturing method comprising:
searching for a signal which uses a predetermined clock signal as an operation clock and which is a target to capture;
comparing a frequency of a reference clock signal, which serves as a reference for the predetermined clock signal, and a frequency of the predetermined clock signal;
estimating precision of the reference clock signal; and
controlling correction of the frequency of the predetermined clock signal based on the reference clock signal when the estimated precision of the reference clock signal is equal to or greater than a predetermined threshold.
